(19) United States
(12) Patent Application Publication
(10) Pub. No.: US 2011/0228565 A1
(43) Pub. Date: Sep. 22, 2011

(54) SWITCHMODE POWER SUPPLY FOR DIMMABLE LIGHT EMITTING DIODES

(76) Inventor: John M. Griffin, Hanover Park, IL (US)

(21) Appl. No.: 12/724,541

(22) Filed: Mar. 16, 2010

(51) Int. Cl. H02M 3/335

(52) U.S. Cl. 363/21.01

(57) ABSTRACT

A power supply has a rectifier for producing a supply voltage from an AC source. A transformer includes a primary winding, a secondary winding, and an auxiliary winding, wherein the supply voltage is applied to the primary winding by a first switch. A controller, powered by voltage at a node, pulses the first switch between conductive and non-conductive states. A second rectifier is coupled between the auxiliary winding and the node. A starting resistor applies voltage derived from the supply voltage to the node. A second switch, in series with the starting resistor, is rendered non-conductive by a delay circuit a defined time period after a given voltage occurs at the node. When the power supply initially activates, the starting resistor supplies voltage to the node, soon thereafter voltage is supplied from the secondary winding. When the defined time period elapses, the delay circuit operationally disconnects the starting resistor.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a switchmode power supply that produces direct current from a higher voltage alternating current; and more particularly to such power supplies for driving dimmable light emitting diodes, such as used in lighting fixtures of a building.

2. Description of the Related Art

Light emitting diodes (LED's) are presently used in buildings as alternative light sources to incandescent and fluorescent light bulbs. LED's consume less power, emit less heat, and have a considerably longer life than other light sources. Nevertheless, the light emitting diodes require relatively low voltage direct current (VDC) and thus a power supply is required if the lighting assembly is to be powered by the standard electrical wiring in the building, The building electrical lighting circuits typically carry alternating current at either 120 volts or 240 volts, depending upon the country in which the building is located. Commercial and industrial buildings also use 277 volts for lighting devices.

A wide variety of techniques can be employed to convert the relatively high voltage alternating current to the lower voltage direct current for the LED's. Many conversion techniques are not very efficient and are undesirable when maximum energy conservation is desired. One of the more efficient techniques employs a switchmode type power supply.

FIG. 1 depicts a common type of switchmode power supply 10, commonly known as a flyback power supply. This disclosure references the flyback power supply but all types of switching power supplies suffer from the same issue of how to start-up a low voltage load from a high voltage source. The alternating current from the building's electrical system 11 is rectified into a direct current by a diode bridge 12. The output of the diode bridge is applied across a series connection of a primary winding 14 in transformer 15 and a semiconductor switch 16. The transformer has a secondary winding 18 that is connected to a rectifier 20 to produce the low voltage direct current for powering a load such as light emitting diodes.

The semiconductor switch 16 is operated by a controller 22 which pulse width modulates operation of the switch. That operation sends current pulses through the primary winding 14 thereby inducing a voltage pulses in the secondary winding 18. Voltage pulses also are induced in an auxiliary winding 30 of the transformer, with via diode 32 provides power at node 34 for operating the controller 22.

When the power switch 24 is closed to activate the power supply, the semiconductor switch 16 is in a non-conductive state, i.e. is turned off, therefore a special start up circuit is required to power the controller 22 and initiate the pulse width modulation of the semiconductor switch. That start up circuit has a drop down resistor 26 that creates a low voltage at node 34 and across a storage capacitor 28 for powering the controller 22. This enables the controller to operate during start up directly off the rectified AC line voltage at the output of the diode bridge. Once the controller 22 begins pulse width modulating the semiconductor switch 16 the resultant current pulses in the primary winding 14 induce voltage in the auxiliary winding 30 which provides sustained low voltage to node 34.

One drawback of this power supply is that energy is continuously dissipated through the start up resistor 26 even after the controller turns on and voltage also is supplied via the auxiliary winding 30. This energy dissipation represents a continuing inefficiency while the power supply is operating. To minimize that energy dissipation, the start up resistor 26 has a relatively large resistance, (e.g. 200 kilohms). That large resistance affects the start up time which is determined by the RC time constant of the start up resistor 26 and capacitor 28 and the peak voltage at the output of the diode bridge 12. If a conventional lighting dimmer is used in place of the power switch 24, at low dimmer settings, it takes an appreciably long time (e.g., 30 seconds) for the LED's to turn on due to the large value of the start up resistor and the low output voltage from the diode bridge 12.

FIG. 2 depicts a flyback type switchmode power supply 40 that has a variation of the start up circuit in which a second semiconductor switch, in the form of a MOSFET 42, is placed in series with the start up resistor 26. The voltage produced by a voltage regulator 44 is slightly greater than the voltage of the Zener diode 41 minus the turn on threshold voltage of the MOSFET 42. This effectively “back biases” the MOSFET 42 and turns it off, however that is not a sharp turnoff and the MOSFET continues to leak current. Additionally there are considerable tolerance issues with predicting the turn on voltage of the controller 22, the voltage regulator 44, and the turn on threshold voltage of MOSFET 42. The result is that the second semiconductor switch 42 never fully turns off and along with the start up resistor 26 continues to dissipate power after start up. Since the start up resistor 26 should be disconnected after start up, it can have a relatively low resistance, (e.g. 2 kilohms) in comparison to the start up resistor in the FIG. 1 circuit. This lower resistance shortens the turn on time of the power supply when connected to a dimmer. Some of power supplies of this type include a voltage regulator for the voltage produced by the auxiliary coil 30 and diode 32.

FIG. 3 depicts a third version of a previous switchmode power supply 50 in which a third semiconductor switch 52 has a conduction path connected between the gate of the second semiconductor switch 42 and ground. The gate of the third semiconductor switch 52 is connected to the output terminal of the transformer auxiliary winding 30. When the controller turns on and voltage is induced across the auxiliary winding 30, that voltage turns on the third semiconductor switch 52, thereby clamping the gate of the second semiconductor switch 42 to ground and fully turning off the second semiconductor switch. As a consequence, once the controller 22 begins operating, the start up resistor 26 is fully disconnected.

All these versions of prior power supplies were susceptible to failure should a short circuit occur at the load connected to the secondary winding 18. If such a short circuit exists when the power switch 24 closes, the power supply will start normally. Although the short circuit load prevents a voltage from being produced across the auxiliary winding 30, the start up circuit maintains the voltage level at node 34 and thus keeps the controller 22 operating. Eventually the short circuit induced current causes the first and second semiconductor switches 16 and 42 to fail catastrophically.

Therefore, it is desirable to provide a power supply with at least partial immunity to effects from a short circuited load. It is further desirable to provide optimal energy efficiency while enabling the power supply to be used for dimmable lighting.

### SUMMARY OF THE INVENTION

A power supply is provided to derive a DC output voltage from an AC power source and has an input rectifier for producing a supply voltage from the AC power source. A transformer includes a primary winding, a secondary winding, and an auxiliary winding. The supply voltage is applied to the primary winding by a first switch that changes between conductive and non-conductive states in response to a control signal.

A controller is powered by voltage at a circuit node and produces the control signal in the form of a series of pulses. A second rectifier is coupled between the auxiliary winding and the circuit node to apply a voltage to the circuit node.

A starting resistor applies a voltage, that is derived from the supply voltage, to the circuit node. A second switch is operatively connected to the starting resistor to control application of the voltage derived from the supply voltage to the circuit node. A time delay circuit is activated by production of the supply voltage, wherein a given time period after being activated the time delay circuit causes the second switch to discontinue the application of the voltage derived from the supply voltage to the circuit node.

### BRIEF DESCRIPTION OF THE DRAWINGS

FIG. 1 is a schematic block diagram of a first prior power supply;

FIG. 2 is a schematic block diagram of a second prior power supply;

FIG. 3 is a schematic block diagram of a third prior power supply; and

FIG. 4 is a schematic block diagram of a first power supply according to the present invention.

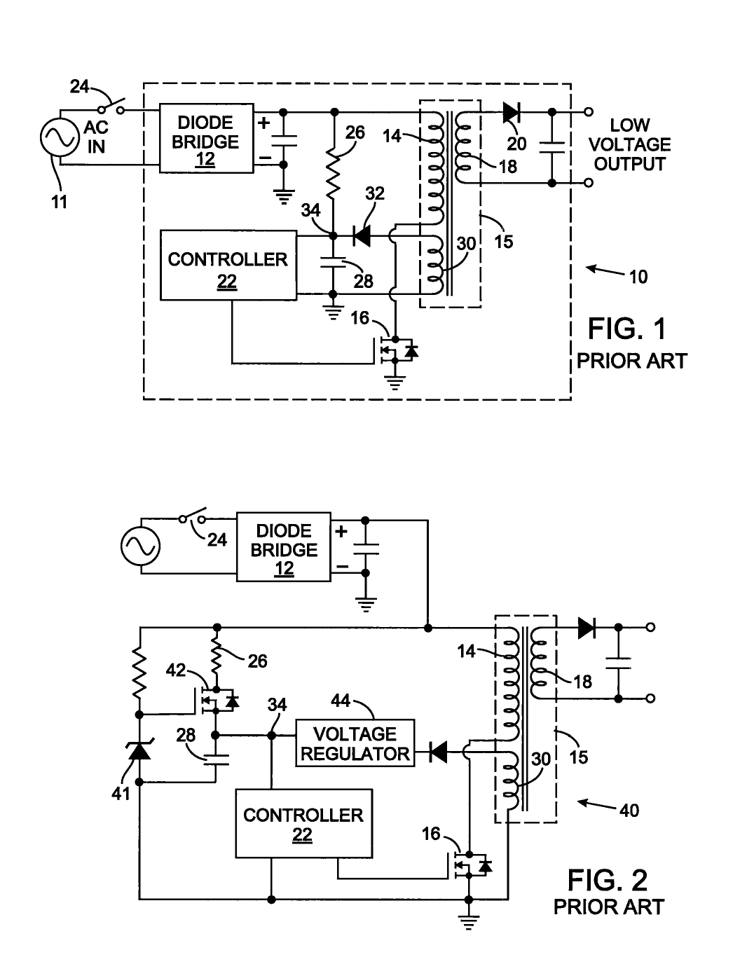

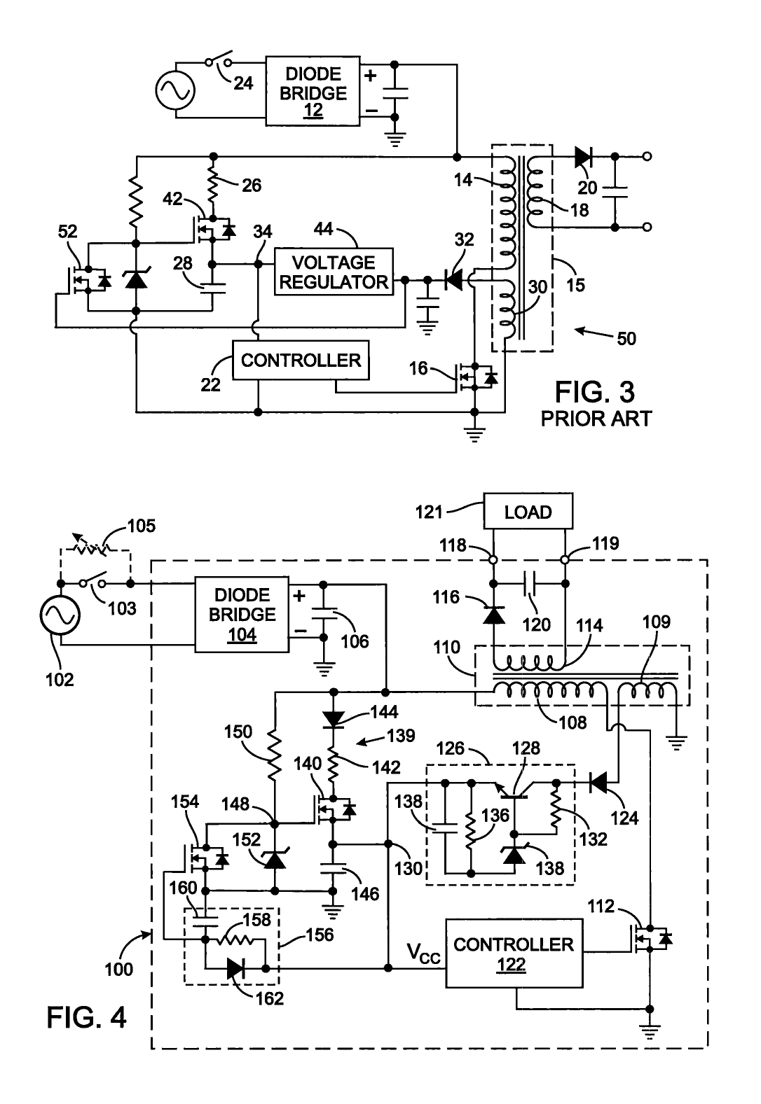

### DETAILED DESCRIPTION OF THE INVENTION

With reference to FIG. 4, a switchmode power supply 100 receives alternating current at 120 volts, 240 volts, or 277 volts from an external power source 102, such a utility company power line. The external power source 102 is connected to the power supply 100 by a switch 103, such as a standard wall switch of the electrical wiring system in a building. Alternatively, a standard light dimmer 105, schematically depicted as a variable resistor, may be substituted for the wall switch 103. Within the power supply 100, an input rectifier, such as a diode bridge 104, converts the alternating current into direct current at output terminals across which a first smoothing capacitor 106 is connected.

The negative output terminal of the diode bridge 104 is attached to circuit ground and the positive terminal is connected to one end of a primary winding 108 of a transformer 110. The opposite end of the primary winding 108 is connected to circuit ground through the conduction path of a first switch 112. Preferably, the first switch is a semiconductor device, such as a MOSFET. The first switch 112 has a control terminal, such as the gate of the MOSFET, which receives a control signal from a controller 122. The controller 122 pulse width modulates operation of the first switch 112 in a conventional manner. Preferably, the controller 122 provides power factor correction (PFC) to “smooth out” the pulsating AC current resulting from PWM operation of the first switch 112 and thereby improving the power factor of the power supply. Implementing power factor correction increases the power handling capability of the power supply. Power factor correction also is desirable in order for the solid state lighting system for qualify for the Energy Star program of the United States Department of Energy. For example, the controller 122 may be a transition-mode PFC controller, such as model L6562 produced by STMicroelectronics, 39, Chemin du Champ des Filles, C. P. 21, CH 1228 Plan-Les-Ouates. GENEVA, Switzerland.

The transformer has a secondary winding 114, with one end coupled by an output rectifier, such as an output diode 116, to a first output terminal 118 of the power supply. The other end of the secondary winding 114 is connected directly to a second output terminal 119. A second smoothing capacitor 120 is connected across the output terminals 118 and 119. The load 121, in this case an assembly of light emitting diodes, is connected to the output terminals 118 and 119.

The transformer 110 also has an auxiliary winding 109 in which current is induced by the current flowing through the primary winding 108. One end of the auxiliary winding 109 is connected to the circuit ground and an opposite end is connected by an auxiliary rectifier, for example a first diode 124, to a linear voltage regulator 126. Any well known voltage regulator can be employed to utilize the rectified voltage from the first diode 124 to produce a relatively stable voltage level (Vcc) at a first circuit node 130. That voltage is used to power the controller 122. A storage capacitor 146 is connected between the first circuit node 130 and circuit ground.

The exemplary voltage regulator 126 includes a transistor 128 that has a collector-emitter path connected between the first diode 124 and the first circuit node 130. A first resistor 132 is connected between the collector and the base electrodes of the transistor 128. A cathode of a first zener diode 134 is connected to the base of the transistor 128. The anode of the first zener diode 134 is coupled to the first circuit node 130 by a second resistor 136 and a first capacitor 138 connected in parallel.

The first circuit node 130 is connected to the positive terminal of the diode bridge 104 by a start up circuit 139 comprising a series connection of a second switch 140, a starting resistor 142, and a starting diode 144. The starting diode 144 is poled so that current flows from the positive output terminal of the diode bridge 104 toward the first circuit node 130. These second switch 140, which also may be a semiconductor device such as a MOSFET, has the control input (e.g., a gate electrode) that is connected to a second circuit node 148.

The second circuit node 148 is coupled to the positive output terminal of the diode bridge 104 by a third resistor 150. A second zener diode 152 is connected in a reverse biased fashion between the second circuit node 148 and circuit ground. A third switch 154, which also may be a semiconductor device such as a MOSFET, has a conduction path connected between the second circuit node 148 and circuit ground. The control terminal (e.g., gate electrode) of the third switch 154 is connected to an output terminal of a time delay circuit 156. Any conventional circuit that provides the requisite time delay, as will be described hereinafter, may be used as the time delay circuit 156. A simple RC circuit may be employed. For example as shown in FIG. 4, a timing resistor 158 connects the first circuit node 130 to the control terminal of the third switch 154, which terminal is coupled to circuit ground by a timing capacitor 160. The values of the timing resistor 158 and the timing capacitor 160 define the RC time constant of the delay circuit 156. A second diode 162 is coupled in a reverse biased fashion between the control terminal of the third switch and the first circuit node 130.

When a user desires to activate the load 121, the wall switch 103 or dimmer 105 is operated to convey alternating electric current from the power source 102 to the diode bridge 104 of the power supply 100. This produces a DC voltage across the positive and negative output terminals of the diode bridge. At the time that alternating current is initially applied to the diode bridge 104, the first, second, and third switches 112, 140, and 154 were in nonconductive states. The positive voltage at the output of the diode bridge 104, applied through the third resistor 150, causes the second zener diode 152 to turn on which in turn turns on the second switch 140. Rendering the second switch 140 conductive begins charging the storage capacitor 146 thereby ramping up the supply voltage Vcc at the first circuit node 130. Eventually the voltage Vcc at the first circuit node 130 reaches a level that enables the controller 122 to begin to operate. The positive voltage Vcc at the first circuit node 130 also causes the time delay circuit 156 to commence operation.

Operation of the controller 122 provides a PWM control signal to the control terminal of the first switch 112 (e.g. to the gate of the MOSFET), thereby alternating the switch between conductive and non-conductive states. Alternating the conductive states of the states first switch 112 sends pulses of direct current from the diode bridge 104 through the primary winding 108 of the transformer 110. Those current pulses induce current in the secondary winding 114 which is rectified by the output diode 116 to provide direct current to the load 121. At the same time, the pulsating current flowing through the primary winding 108 also induces a current in the auxiliary winding 109. The current from the auxiliary winding 109 is rectified by the first diode 124 and applied to the linear voltage regulator 126. The resultant regulated voltage is applied to the first circuit node 130 to further charge the storage capacitor 146 and provide the supply voltage Vcc.

At this point in time, the power supply is fully operational with the supply voltage produced from the auxiliary winding 109 being sufficient to continue maintain the operation. As a consequence, voltage is no longer required to be supplied to the first circuit node 130 via the start up circuit 139 and in particular via the second switch 140, the starting resistor 142, and the starting diode 144. Nevertheless, that start up voltage continues to be furnished because the second switch 140 is still conductive at this time.

After the predefined delay period provided by the time delay circuit 156, that circuit applies a positive voltage potential to the control input of the third switch 154 that turns on that switch. This in turn pulls the control input of the second switch 140 to ground potential, thereby turning off that second switch. That latter action deactivates the start up circuit and disconnects the first circuit node from the positive terminal of the diode bridge 104.

The incorporation of the starting diode 144 in the start up circuit 139 is beneficial for a power factor corrected type switchmode power supply. In this such a power supply, the value of first smoothing capacitor 106 is minimized and the voltage on that capacitor is a half sine wave and not a flat line DC level. Without the starting diode 144, the voltage on the storage capacitor 146 would discharge through the parasitic capacitance of the MOSFET second switch 140 and the controller 22 may never receive enough voltage to function.

If upon activating the power supply by operation of either the wall switch 103 or the dimmer 105, a short circuit condition exists across the load terminals 118 and 119, the present circuit configuration prevents a catastrophic failure of the power supply. This is achieved by setting the delay period provided by the delay circuit 156 to be shorter than the interval that the diode bridge 104, the primary winding 108, and the first switch 112 can tolerate the short circuit condition current without failing.

Initiating power supply operation under a short circuit condition, results in the power supply starting in the same manner as described above during a non-short circuit condition. That is, the second switch 140 initially turns on coupling the first circuit node to the positive output terminal of the diode bridge 104 to begin charging the storage capacitor 146. When that capacitor's charge level reaches a point that the voltage (Vcc) at the first circuit node 130 is sufficient to operate the controller 122, that latter component produces a control signal that turns on the first switch 112. This results in a large short circuit condition current flowing through the primary winding 108 and the first switch 112. Because of the effect that the short circuit load has on the secondary winding 114, a voltage is not produced across the auxiliary winding 109. As a consequence, the voltage that normally would be provided by the auxiliary winding and conveyed through the first diode 124 and the voltage regulator 126 to the first circuit node 130 does not occur. Therefore, when the time delay interval provided by delay circuit 156 expires and the third switch 154 turns on which in turn turns off second switch 140, voltage no longer will be applied by either the start up circuit 139 or the voltage regulator 126 to the first circuit node 130. Therefore, the charge across the storage capacitor 146 quickly dissipates and the controller 122 ceases operation turning off the first switch 112.

As the voltage at the first circuit node 130 decays, a level is reached at which the third switch 154 begins to turn off. This causes the voltage on the second Zener diode 152 to increase and eventually reach what is termed the “threshold voltage” of the MOSFET second switch 140. At that time, the second switch 140 begins to partially conduct, maintaining the existing voltage level at the first circuit node 130. The resultant voltage at the first circuit node 130 remains equal to the threshold voltage of the MOSFET third switch 154 (typically no more than 4 volts) and the power supply 100 is at stable equilibrium. The voltage level at the first circuit node 130 remains lower than the minimum voltage required by the controller 122 to operate (e.g. about 12 volts) and so the controller remains in the non-operational state. The only way to restart the power supply 100 is to remove the short circuit and reset the input power.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A power supply for producing an output voltage from an AC power source comprising:
an input rectifier for producing a supply voltage from the AC power source;
a first switch that changes between conductive and non-conductive states in response to a control signal;
a transformer comprising a primary winding, a secondary winding, and an auxiliary winding, wherein the supply voltage is applied to the primary winding by the first switch;
a circuit node;
a controller powered by voltage at the circuit node and producing the control signal;
a second rectifier coupled between the auxiliary winding and the circuit node;
a starting resistor for applying a voltage derived from the supply voltage to the circuit node;
a second switch operatively connected to the starting resistor to control application of the voltage derived from the supply voltage to the circuit node; and
a time delay circuit responsive to production of the supply voltage, wherein a given time period after being activated, the time delay circuit causes the second switch to discontinue the application of the voltage derived from the supply voltage to the circuit node.

2. The power supply as recited in claim 1 wherein the second switch has a first control terminal and changes between conductive and non-conductive states in response to voltage at the first control terminal; and an output signal produced by the time delay circuit controls the voltage at the first control terminal.

3. The power supply as recited in claim 2 further comprising a Zener diode having a cathode connected to the first control terminal and an anode connected to a reference voltage node.

4. The power supply as recited in claim 2 further comprising a third switch having a second control terminal and changing between conductive and non-conductive states in response to voltage at the second control terminal, wherein the output signal from the time delay circuit is applied to the second control terminal and wherein the conductive and non-conductive states of the third switch control the voltage at the first control terminal.

5. The power supply as recited in claim 1 further comprising a third switch operating in response to an output signal from the time delay circuit, wherein operation of third switch varies a voltage that operates the second switch.

6. The power supply as recited in claim 1 further comprising a starting diode connected in series with the starting resistor.

7. The power supply as recited in claim 1 further comprising a starting diode connected in series with the starting resistor and allowing current to flow through the starting resistor only in a direction from the input rectifier to the circuit node.

8. The power supply as recited in claim 1 wherein the controller provides power factor correction.

9. The power supply as recited in claim 1 further comprising a voltage regulator in series with the second rectifier between the between the auxiliary winding and the circuit node.

10. The power supply as recited in claim 1 further comprising an output rectifier connected to the secondary winding for producing the output voltage.

11. The power supply as recited in claim 1 wherein the time delay circuit is activated upon a given voltage occurring at the circuit node.

12. A power supply for producing a output voltage from an AC power source comprising:
an input rectifier for connection to the AC power source and having an output terminal at which a supply voltage is produced;
a first switch that changes between conductive and non-conductive states in response to a control signal;
a transformer comprising a primary winding, a secondary winding, and an auxiliary winding, wherein the supply voltage is applied to the primary winding by the first switch;
a circuit node;
a controller having an input voltage terminal coupled to the circuit node and the controller producing the control signal in the form of a series of pulses;
an auxiliary rectifier through which current flows between the auxiliary winding and the circuit node;
a second switch having a first control terminal;
a starting resistor connected in series with the starting resistor, wherein current flows between the output terminal of the rectifier and the circuit node through the second switch and the starting resistor;
a third switch having a conduction path connected between the first control terminal of the second switch and a reference voltage level, the third switch having a second control terminal; and
a time delay circuit that, a defined time period after a given voltage occurs at the circuit node, produces an output control voltage level that is applied to the second control terminal thereby causing the third switch to place the second switch is a non-conductive state.

13. The power supply as recited in claim 12 further comprising a starting diode connected in series with the starting resistor and the second switch.

14. The power supply as recited in claim 12 further comprising a starting diode connected in series with the starting resistor and allowing current to flow through the starting resistor only in a direction from the input rectifier to the circuit node.

15. The power supply as recited in claim 12 further comprising a Zener diode having a cathode connected to the first control terminal and an anode connected to the reference voltage level.

16. The power supply as recited in claim 12 wherein the controller provides power factor correction.

17. The power supply as recited in claim 12 further comprising a voltage regulator in series with the second rectifier between the between the auxiliary winding and the circuit node.

18. A power supply for producing a output voltage from an AC power source comprising:
an input rectifier for connection to the AC power source and having a first terminal and a second terminal;
a transformer comprising a primary winding, a secondary winding, and an auxiliary winding;
a first switch that changes between conductive and non-conductive states in response to a control signal and connected in series with the primary winding between the first terminal and a second terminal;
a first circuit node;
a controller having an input voltage terminal coupled to the first circuit node and producing the control signal in the form of a series of pulses;
an auxiliary rectifier through which current flows between the auxiliary winding and the first circuit node;
a second switch having a first control terminal;
a starting resistor connected in series with the second switch between the first terminal and the first circuit node;
a storage capacitor connected to the first circuit node and the second terminal;
a third switch having a conduction path connected between the first control terminal of the second switch and the second terminal, the third switch having a second control terminal; and
a time delay circuit that, a defined time period after a given voltage occurs at the first circuit node, produces an output control voltage level that is applied to the second control terminal thereby causing the third switch to become conductive which in turn causes the second switch to become non-conductive.

19. The power supply as recited in claim 18 further comprising a diode connected in series with the starting resistor and the second switch.

20. The power supply as recited in claim 18 further comprising a Zener diode having a cathode connected to the first control terminal and an anode connected to the second terminal; and a resistor coupling the first terminal to the first control terminal.

21. A power supply for producing an output voltage from an AC power source comprising:
an input rectifier for producing a supply voltage from the AC power source;
a first switch that changes between conductive and non-conductive states in response to a control signal;
a transformer comprising a primary winding and a secondary winding, wherein the supply voltage is applied to the primary winding by the first switch;
a circuit node;
a controller powered by voltage at the circuit node and producing the control signal;
a voltage regulator having an input connected to the transformer and an output connected to the circuit node.
a starting resistor for applying a voltage derived from the supply voltage to the circuit node;
a second switch having a first control terminal and being operatively connected to the starting resistor to control application of the voltage derived from the supply voltage to the circuit node; and
a time delay circuit responsive to production of the supply voltage, wherein a given time period after being activated, the time delay circuit causes the second switch to discontinue the application of the voltage derived from the supply voltage to the circuit node.

22. The power supply as recited in claim 21 further comprising a second rectifier coupled between the input of the transformer and the voltage regulator.

23. The power supply as recited in claim 21 further comprising a third switch having a second control terminal and changing between conductive and non-conductive states in response to voltage at the second control terminal, wherein the output signal from the time delay circuit is applied to the second control terminal and wherein the conductive and non-conductive states of the third switch control the voltage at the first control terminal.
